(19) United States
(12) Patent Application Publication
(10) Pub. No.: US 2016/0335727 A1
(43) Pub. Date: Nov. 17, 2016

(54) System and method of real-time imaging and analysis of real-world objects

(71) Applicant: Raymond Jimenez, Woodhaven, NY (US)

(72) Inventor: Raymond Jimenez, Woodhaven, NY (US)

(21) Appl. No.: 15/153,659

(22) Filed: May 12, 2016

Related U.S. Application Data
(60) Provisional application No. 62/160,262, filed on May 12, 2015.

(51) Int. Cl. G06Q 40/08; G06Q 30/00

(52) U.S. Cl. CPC G06Q 40/08; G06Q 30/0185

(57) ABSTRACT

A system that determines the extent of damage on structures such as vehicle body panels. The system utilizes common computing devices such as a smartphone or tablet. The system compares captured images with database information and then provides a damage calculation. Alternatively the system analyzes captured images using estimated real-world dimensions obtained from object detection technology.

### CROSS-REFERENCE TO RELATED APPLICATIONS

This application claims priority to U.S. Provisional Patent Application No. 62/160,262, filed May 12, 2015.

### BACKGROUND OF THE INVENTION

1. Field of the Invention

The present invention relates to systems and methods for calculating vehicle damage, documenting vehicle conditions, and insurance fraud mitigation.

2. Background

In the automobile industry, auto accidents are an unfortunate but everyday occurrence. Insurance companies, first responders such as police and fire department personnel, collision specialists, and tow truck drivers often require accurate documentation of damage to a vehicle. For example, automobile insurance companies would benefit from having accurate documentation, evidence, and damage calculations at the time of the accident, as such information would greatly reduce insurance fraud. Typically, insurance companies, collision specialists, automobile repair facilities, and damage appraisers must record damage by visual inspection and then documenting on paper or by entering into a computing device. However, such practice does not provide a detailed analysis of the structural damage to the vehicle, and is also ripe for insurance fraud. For example, there is a need in the auto insurance industry to prevent auto repair shops from fraudulently increasing the damages on a vehicle in an attempt to receive a higher settlement under the insurance policy.

U.S. Pat. No. 7,889,931 describes a vehicle inspection station that uses several cameras to capture images of a car. For detecting whether a car has damage, at least a portion of an image is compared with a previously stored image of the vehicle. However, the vehicle inspection station is not configured to assess the damage and/or provide an estimate for the repair of the damage. It also requires that the vehicle be brought to the station.

US2014/0201022 describes a system that determines an estimate of damage to a surface area of a vehicle. However, this system relies on a device that emits light beams and relies on three-dimensional analysis. This system also relies on triangulation transformation techniques.

### BRIEF SUMMARY OF THE INVENTION

A system that determines the extent of damage on structures such as vehicle body panels. The system utilizes common computing devices such as a smartphone or tablet. The system compares captured images with database information and then provides a damage calculation. The present invention reduces the possibility of fraud, which is known to be a prevalent problem within the auto insurance industry. The present invention prevents this type of fraud because the user can document damage at the time of the accident for increased transparency throughout the claims process. The adjuster, during his/her inspection of the vehicle, can access the damage information documented by the user at the time of the accident. This allows the adjuster to confirm that additional damages are not present on the vehicle, providing an indication that fraud has occurred. Similarly, car rental companies can document current damage conditions prior to the rental, and then compare with damage conditions after the rental is completed. This invention allows for before and after digital comparisons useful in for example insurance claims and car rentals, where vehicle walk-arounds have traditionally been done by visual inspection and pen and paper documentation. In addition, parking garage facilities can use the present invention to document and image the vehicle condition before and after parking.

### BRIEF DESCRIPTION OF THE DRAWINGS

FIG. 1 illustrates the body panels of an automobile.

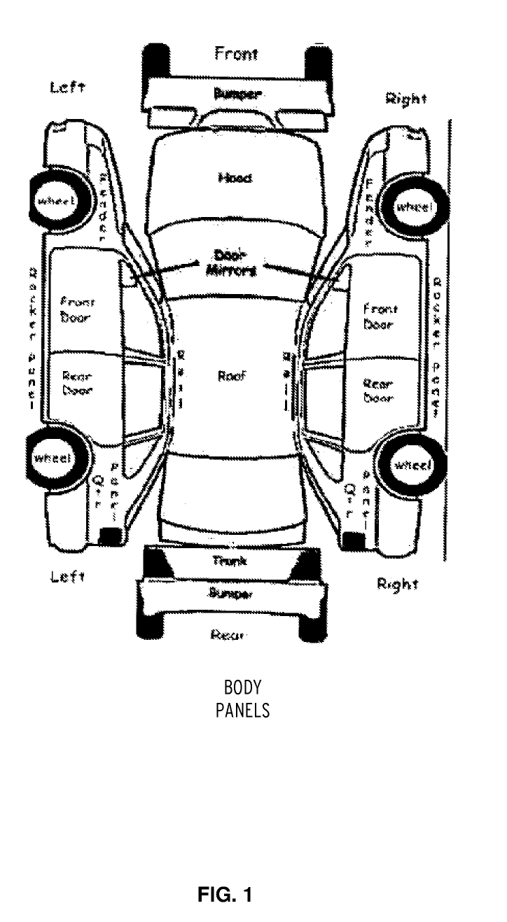

FIG. 2 Captured image 202 on Imaging device 204.

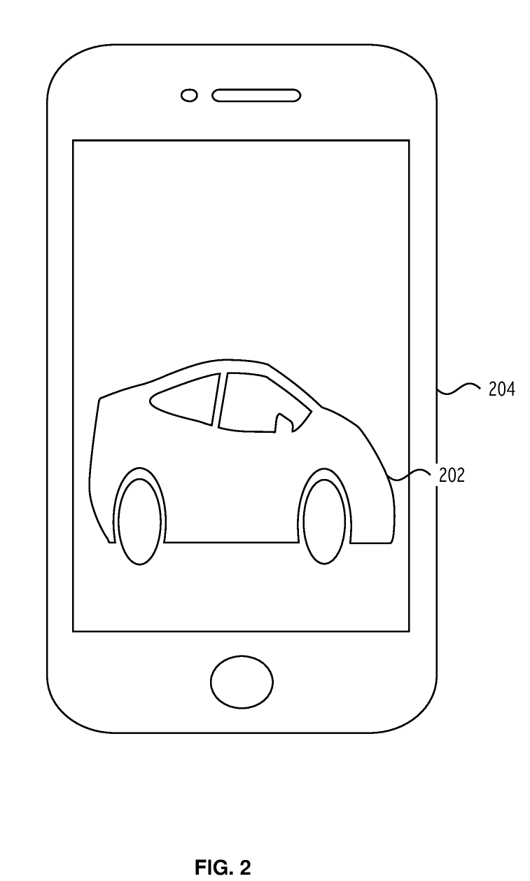

FIG. 3 Imaging device 302 displaying OEM image and real-time image.

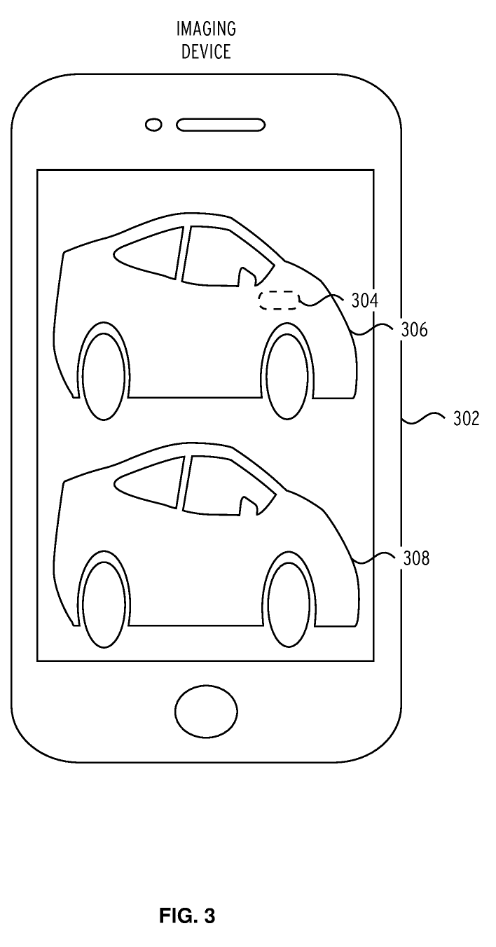

FIG. 4 illustrates an aspect of the subject matter in accordance with one embodiment.

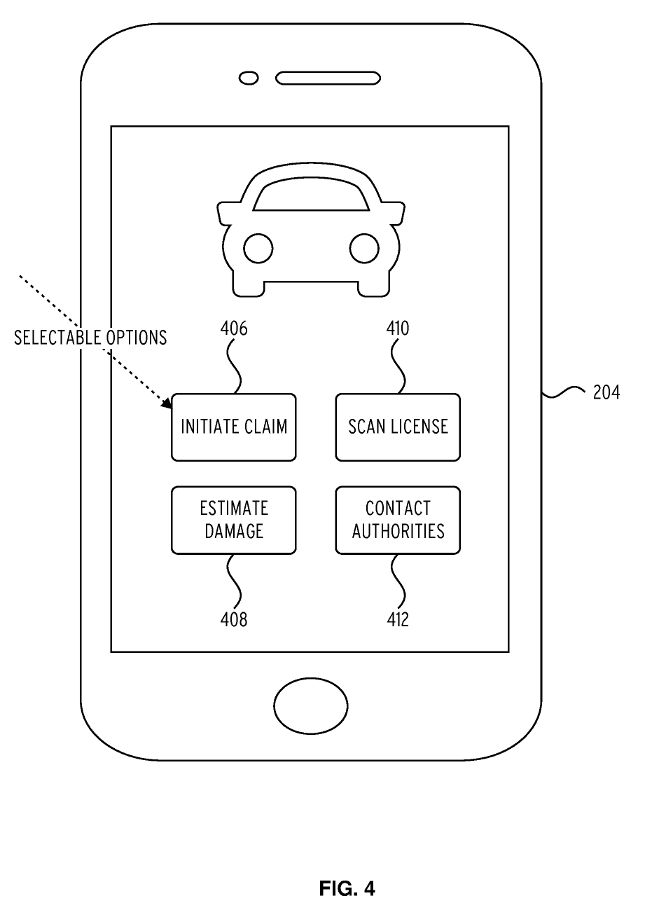

FIG. 5 illustrates an aspect of the subject matter in accordance with one embodiment.

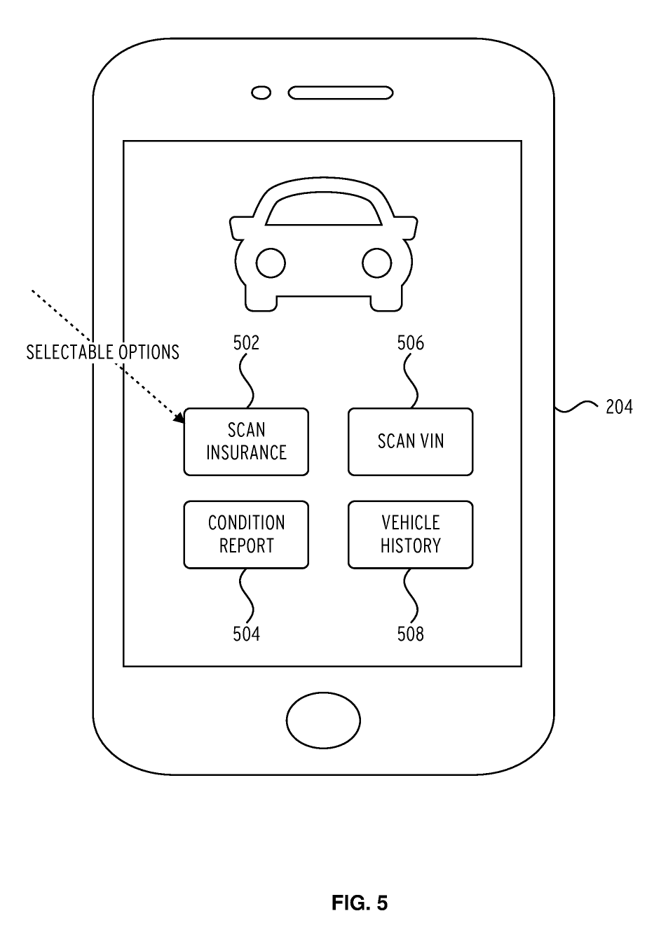

FIG. 6 illustrates an aspect of the subject matter in accordance with one embodiment.

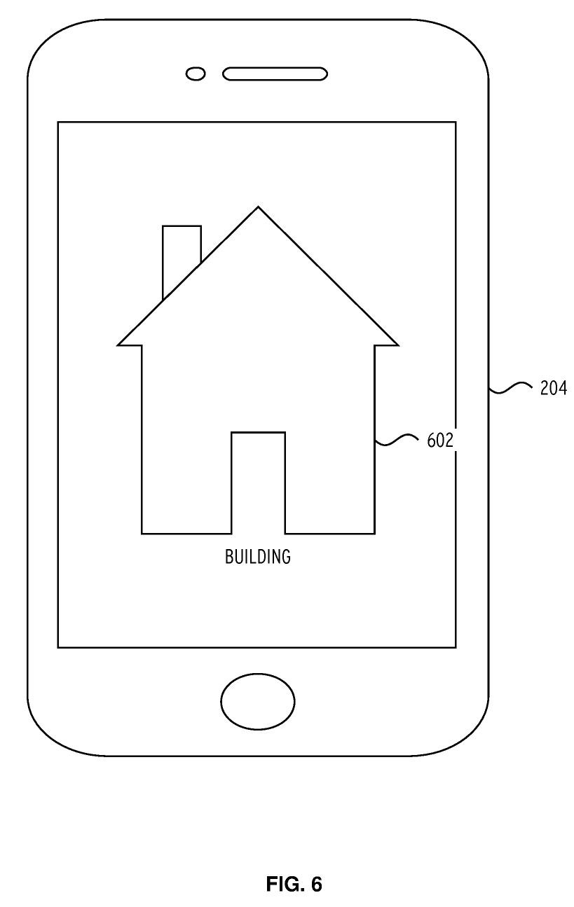

FIG. 7 illustrates an aspect of the subject matter in accordance with one embodiment.

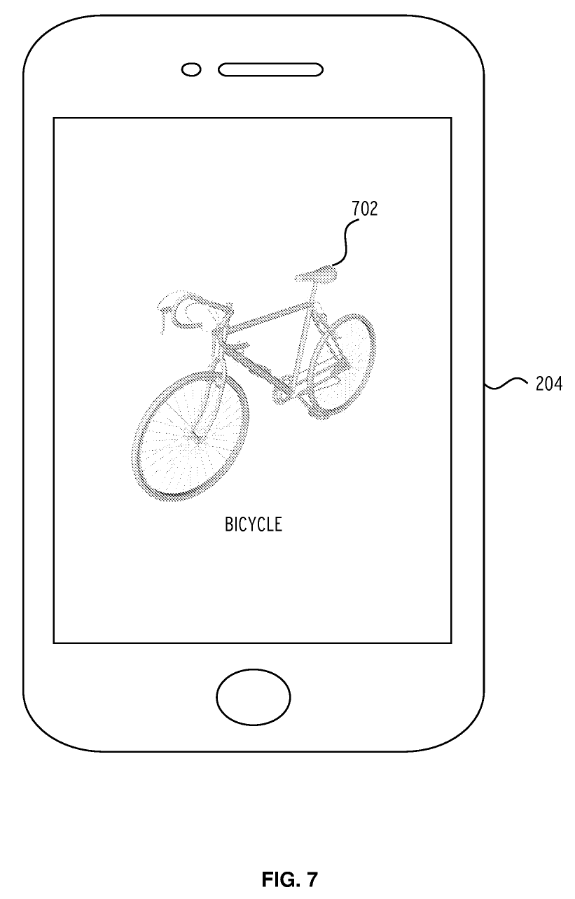

### DETAILED DESCRIPTION OF THE PREFERRED EMBODIMENTS

The system includes an image capturing device, such as a camera, smartphone, or tablet. The image capturing device is connected, either wired or wirelessly, to a processor. The processor is connected to one or more storage devices. The storage devices contain one or more databases of information such as vehicle information, structure information, CAD files of vehicle body panels, etc. The processor and storage device may be a central processing unit (CPU), and the processor or the storage device may be in the “cloud” i.e. processed or stored on a remote server. These components are hereinafter referred to as a “device,” and components may be connected wired or wirelessly. A device can ideally be a smart device such as an Apple iPhone, Apple iPad or Android-powered device, as is known in the art. The device is utilized to determine damage to an object, which may be, for example, a car, an automobile, a truck, a motorbike, an airplane, a boat, a ship, or a building. The damage may include dents, scratches, deviations of shut lines, and other anomalies.

Using the device to capture and document damage, damage information is digitally recorded. The damage information can be uploaded to a database and matched with a particular vehicle identification number (VIN). This real-time information can be collected and stored as vehicle history information. In addition to VIN information, the user can use the device to capture insurance information of parties involved, and document witness identification and statements. The device can also log global positioning system (GPS) coordinates of the device's position, so for example the accident location can be documented.

While operating the device, the user takes a picture or holds the device over the damaged area to capture a still shot. Additionally the user can capture video with the imaging device. The captured image or video is processed by the device and a damage calculation is performed. This is accomplished by first converting the captured image to a two-dimensional array of pixels. In one embodiment, pixels are converted to grayscale and each pixel is assigned a light intensity value. In another embodiment, color values, such as RGB values, are assigned to each pixel. In the case of automobiles where the user captures an image of a damaged body panel, a database containing body panel dimensions is accessed by the device. Information relating to the matching original manufacturer equipment (OEM) body panel for that particular vehicle is found in the database and stored as an image. Since the real-world OEM dimensions are known, real-world pixel size can be determined in the captured image. Alternatively the user can input real-world dimensions into the computing device.

Once the image capturing device captures an image, the processor converts the image to a digital image consisting of pixels. The digitized image is stored in the storage device and is compared to a data bank of CAD images containing OEM specifications. Damages and other abnormalities will be evident from the comparison analysis. For example, pixel size will be determined based on real-world measurements, which can be entered or acknowledged by the user. The real-world measurements of the digitized objects, such as a vehicle body panel, is computed based on the number of pixels. Alternatively, the processor, either locally or remotely, can analyze the captured image or video to recognize and analyze features such as body panel gaps on automobiles, also known as shut lines. A comparison between the measurements of the subject shut lines and of known OEM measurements can be done to determine the deviations from OEM specifications. These deviations may be used to determine the extent of damage to the body panel or vehicle.

An analysis is performed to compare the relative light intensity values of the captured image with values that are stored in the database. If, for example, a dent is present in the captured image, relative light intensity values for the pixels representing the damaged area would deviate from the database values representing the OEM body panel. As the dimensions in the OEM body panel are known, the true area and location of damage on the captured image can be computed by counting the pixels that have intensity deviations. Light intensities are compared between neighboring pixels, and smoothing functions can be used to improve detection accuracy. The deltas between the neighboring pixels of the captured image are compared to the deltas of the corresponding pixels of the OEM image found in a database. The computing device counts the pixels corresponding to the intensity deviations. By comparing both deltas and absolute light intensities, areas of damage can be detected even when the images of the damaged vehicle are captured under differing lighting conditions. Damage calculations can also be performed without comparing to known databases. This is accomplished by using estimated values for vehicle body panels in conjunction with object or subject detection technology known in the art such as facial recognition. Thus, the present invention can capture an image of a body panel which has a scratch on the surface, and provide the user with the dimensions of the scratch without comparing to a database of OEM values. The pixel analysis computes the number of pixels representing the damage, and the object or subject detection technology provides estimated real-world dimensions, so that the damage dimensions can be estimated.

Depending on the device used, video capture and three-dimensional (3D) imagery can be captured to document damage. Certain devices are capable of creating holographic images and representations of the subject or automobile. Numerical calculations known in the art are performed on images and features of images to determine dimensional characteristics such as length, width, height and depth. Real-world measurements can also be entered and/or acknowledged by the user.

In the auto industry, certain technologies known in the art of auto repairs can make comparisons between stored information and an image which has been captured and digitized, i.e. pixelized. For example, the present invention can recognize color, make and model of automobiles by comparing the digitized image with a database of computer aided design (CAD) files which contain data on every vehicle manufactured. As is known in the art of image processing, captured images are digitized and stored as arrays of pixels. The user may either take still images of the subject object, or the user may use video mode to walk around the object to scan multiple images of the subject object. Examples of software which can perform this function are “Matrix Code Camera 3D” by Useless Creations Pty Ltd. and “3D Camera Studio” by Juicy Bits. Furthermore, the captured images or video may be used to create a three-dimensional or holographic representation of the automobile or other subject. This function can be performed by, for example, “3D Camera Studio” by Juicy Bits. Each pixel is numbered and assigned a designated location based on the CAD dimensions of all body panels and vehicle structures. The CAD files reference OEM data, and the OEM data can be obtained through various sources. Such sources include www.blueprints.com, from Evolution Graphics B.V., which provides dimensions and details of most manufactured automobile makes and models, such as weight, length, width and height of vehicle body panels and structures. Other sources of OEM data include GrabCAD and Stratasys, which provide dimensional and other information on automobiles as well as a wide range of structures.

To improve the accuracy of the captured images, the algorithm of the present invention provides the user with guideposts displayed on the screen of the device used to capture the image. For example, the user would indicate the section of the vehicle being captured, such as a fender, or multiple sections and body panels, or the entire vehicle. The device would display on screen via an onscreen guide the designated sections, such as a generic fender outline, which the user can use to distance the device to capture the optimal image size. The onscreen guide also provides for display of every make and model of vehicle, or subsections thereof. Further image processing can be done within the software to expand or contract the image so that the appropriate size is achieved to properly correspond with the sizing of the OEM images found on the database. User friendly alert features such as playing a sound or changing the screen background to green, for example, can be implemented in the software so the user is notified of the proper positioning of the image capturing device. Once the fender is identified by the system, the exact make and model of the vehicle will then be displayed, and the user will see the correct fender outline on the display of the device rather than a generic fender.

Additional analysis of body panel gaps or shut lines can be performed by comparing to shut line information found in one or more databases. In this way, evidence of structural damage or shoddy repair work can be documented. For example, shut lines around the vehicle hood and trunk should be symmetric. The present invention can easily detect variations in shut line dimensions which can be incorporated into the damage analysis. Comparison to CAD information will reveal whether the vehicle's chassis is outside of specifications and alignment is necessary.

In some instances, the user may not have a good vantage point or lighting may be poor and capture image automatic analysis may not be possible. In such instances, the user can manually enter damages into the computing device. Similarly, in the event of system outages or other technical failure, the user can enter measurements of damaged areas as a fail-safe which can be later uploaded to a database once connectivity is restored. Entries can include approximate damage dimensions such as area, depth, and length. The user may enter numeric values, or the user may draw onto the database image on the screen of the device the areas of damage. The computing device will detect the user inputs drawn onto the screen via touchscreen technology known in the art and compute damage dimensions based on the user inputs. The user can select onscreen, for example by finger touch or stylus, the pixels corresponding to the damaged areas on the OEM body panel. As a further fail-safe, the user can communicate to a third-party on the back-end the damaged areas, and the third-party can manually input dimensional damage information, or alternatively can select pixels on the OEM body panel. For example, the third-party can select displayed pixels via finger touch or stylus.

Captured images can be compared with databases containing images of vehicle body panels such that the device can recognize and determine the make, model, year or year range and body-style of a particular vehicle. Alternatively, the user can scan or enter the VIN of the vehicle. This can be done by capturing an image or still shot of the VIN plate located under the windshield of most vehicles, or on the doorjamb sticker. Optical character recognition (OCR) software, as is known in the art, can recognize the alphanumeric symbols of the VIN. VIN recognition provides for vehicle history data, such as prior insurance claims, prior damage reported, and official Motor Vehicle history. The user can also manually enter the VIN, vehicle year, make, model and trim.

The resulting data of the damage detection functionality can be used to generate a report showing damages information and the cost of replacement parts and/or cost of repairs. Damages information includes the real-world dimensions of the damaged areas. For example, the report may include numerical information on the damage detected, such as a five-inch scratch or a circular dent having diameter of seven inches. Repair cost information is found on various databases, such as those provided by Nexus Collision Repair Center, a division of Fleet Services Group LLC, and Mitchell Repair Information Company LLC. The present invention automatically inputs data to repair estimating software so as to seamlessly report damage information and repair information. Damage information can also be inputted manually by either the user or a third-party in communication with the user, so that a report can be generated in the event of errors or failure in the damage detection functionality.

The user is presented with options on his/her device. Such options include receiving a complete CAD report or similar graphical representation displaying one or more images representing the damaged and undamaged vehicle, reports on structural integrity issues, repair estimates for body work or paintless or paint-free dent removal, and the option to make an insurance claim. Repair estimates can be provided by integration with repair-estimating technology known in the auto repair industry. The application embodying the present invention will also document driver licenses and insurance cards as part of the insurance claims process. The option will also be available to contact first-responders and other emergency assistance, as well as transmitting user selected data to authorities and first-responders.

If the user chooses to make an insurance claim, the user can be provided with a projected settlement, reducing the insurance adjustment processing time. The user can then bid the repair job to repair facilities, and may schedule an appointment or towing with his/her chosen repair facility. The system can also notify repair facilities with the damage calculations, affected body parts and part numbers necessary to complete the repair. The application embodying the present invention can also be used to create a community of users or market participants who can buy or sell damaged vehicles, since valuable data can be provided to the market participants such as damage and repair estimates.

The present invention reduces the possibility of fraud, which is known to be a prevalent problem within the auto insurance industry. For example, the present invention would apprise an auto insurance company if an auto repair shop fraudulently increased the damages on a vehicle in an attempt to receive a higher settlement under the insurance policy. The present invention prevents this type of fraud because the user can document damage at the time of the accident for increased transparency throughout the claims process. Users may be drivers of vehicles involved in accidents, local authorities such as police officers and firemen, insurance claims adjusters, etc. Further, the present invention would help repair facilities in the repair process by providing parts and part numbers necessary to complete the repair. In addition, comparison to the CAD information will reveal whether the vehicle's chassis is outside of specifications and alignment is necessary.

The application embodying the present invention can also be used to create a community of users or market participants who can buy or sell damaged cars, since valuable data will be provided to the market participants such as damage and repair estimates. Information may be displayed in the app in the form of a structural report or condition report. The structural or condition report provides information relating to vehicle and body panel damage. For example, the structural report may provide information relating to shut line deviations from OEM specifications. Structural or condition reports will greatly add transparency for users. Traditionally, vehicle history reports have been one of few resources available to users and consumers performing diligence on vehicles. However, vehicle history reports provide little to no information relating to prior damages sustained by the vehicle. The structural or condition report provided by the present invention presents users vehicle history as well as detailed damage analysis information including prior damage to body panels and prior structural damage. Reports are linked to the vehicle identification number, which the device can scan from information present on a vehicle doorjamb. Scanning of such information is commonly done to generate vehicle history reports by Carfax, AutoCheck, VIN Audit, and Manheim reports. For example, the image capturing device can scan the barcode located on a doorjamb sticker. The report generated by the present invention will not only provide traditional vehicle history information, but also information related to prior body panel and structural damage. The application embodying the present invention will also scan driver licenses and take insurance card photos as part of the insurance claims process.

The present invention will also protect consumers who are purchasing a repaired, rebuilt or salvaged vehicle. The invention will assist consumers wanting to make a purchase of any type of vehicle, including but not limited to cars, boats, motorcycles, bicycles and the like, in addition to any item where structural integrity is vital. Detailed CAD information is available for a wide range of structures, and this invention will allow for the determination of any and all anomalies and structural abnormalities.

Data that is collected by the present invention can be used to create a database to supplement vehicle histories. This allows the user to view not only official Motor Vehicle records, but also data that has been collected by users of the invention, for a more complete vehicle history. Traditional vehicle history reports are linked to a vehicle identification number (VIN) and generally show information related to title records, salvage and insurance claims and total loss records, odometer readings and accident records. Vehicle history reports are currently generated by companies such as Carfax, AutoCheck, and VIN Audit and also by the National Motor Vehicle Title Information System (NMVTIS). Traditional vehicle history reports do not provide detailed information on body and structural damage sustained by a vehicle. The present invention generates reports containing not only traditional vehicle history information, but also detailed information relating to vehicle body panel and structural damage, such as shut line deviations. The detailed damage reports provided by the present invention will provide consumers, insurance companies, automobile dealers and other industry participants with greater transparency on vehicle history.

The present invention can also be used to document and expedite construction verifications (“sign-offs”) using the same process of capturing three-dimensional (3D) images and comparing to stored CAD architectural plans, such as those filed with municipalities and agencies such as the Department of Buildings. The present invention would not only expedite the inspection process, but also ensure that the building structures or other features are in compliance with building codes. Likewise, the present invention would be useful for insurance companies to validate construction work so as to facilitate contractor draws on claim payments.

Additional uses include facilitating the purchasing of items such as bicycles, motorcycles, boats, planes, ships or any solid object capable of being photographed and pixelized by providing evidence of anomalies or structural variances to the user.

What is claimed is:

1. A system that determines a calculation of damage to a solid object, the system comprising:
an image capturing device;
a computing device that processes images captured by the image capturing device to detect damaged areas and compares data from the processed images to data found in known databases.

2. The system of claim 1, wherein the computing device processes the captured images to detect deviations on surface areas.

3. The system of claim 1, wherein the computing device performs a comparison of data processed from captured images to stored databases, and detects the damaged areas based on the comparison.

4. The system of claim 1, wherein the image capturing device is an integral component of the computing device.

5. The system of claim 1, wherein the solid object is a vehicle.

6. The system of claim 1, wherein the solid object is a motorcycle, ship, bicycle or building.

7. A method for determining a calculation of damage to a solid object, comprising:
capturing one or more images of the solid object and digitizing said images;
storing the digitized images onto a storage device;
processing the images to generate data; and
comparing the data to information stored on one or more databases.

8. The method of claim 7, wherein the solid object is a vehicle.

9. The method of claim 7, wherein the solid object is a motorcycle, ship, bicycle or building.

10. A non-transitory computer program storage medium, comprising:
a non-transitory computer program storage medium containing a computer program that causes a computing device to receive from an image capturing device digital images which are representative of a solid object,
process the digital images to detect damaged areas, and
generate a report.

11. The non-transitory computer program storage medium of claim 10 where the solid object is the surface area of a vehicle.

12. The non-transitory computer program storage medium of claim 10 where the solid object is the surface area of a motorcycle, ship, bicycle or building.
